(19) United States
(12) Patent Application Publication
(10) Pub. No.: US 2004/0181954 A1
(43) Pub. Date: Sep. 23, 2004

(54) Shaving implement having improved pivot axis location

(75) Inventors: Thomas A. Follo, Milford, CT (US); Paul D. Richard, Shelton, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH (US)

(21) Appl. No.: 10/788,096

(22) Filed: Feb. 26, 2004

Related U.S. Application Data
(60) Provisional application No. 60/451,023, filed on Feb. 28, 2003.

(51) Int. Cl. B26B 21/00

(52) U.S. Cl. 30/527

(57) ABSTRACT

In a shaving implement a razor cartridge is pivotally coupled to a handle for rotational movement about a pivot axis. The razor cartridge includes a leading surface and a trailing surface and at least one blade positioned between the leading and trailing surfaces, the blade defining a cutting edge that is at least partially exposed. The pivot axis is located adjacent to the leading surface so that during a shaving operation, externally applied forces generated by drawing the razor cartridge and thereby the exposed portion of the cutting edge over a hirsute surface, causes the razor cartridge and the cutting edge to rotate into the hirsute surface.

### CROSS-REFERENCE TO RELATED APPLICATIONS

This application is entitled to the benefit of and incorporates by reference essential subject matter disclosed in Provisional Patent Application No. 60/451,023 filed on Feb. 28, 2003.

### FIELD OF THE INVENTION

The present invention is generally related to wet shave razors, and is more specifically directed to razors employing razor cartridges having a pivot axis that allows the razor to angularly rotate towards a hirsute surface in response to an externally applied force.

### BACKGROUND OF THE INVENTION

In general, wet shave razors sold today have a blade-carrying razor cartridge, either permanent or disposable, mounted on a handle. The cartridge is usually angularly moveable relative to the handle to follow the contours of a hirsute surface. However, because the axis about which the razor cartridge is movable is not typically positioned to facilitate adequate engagement of the cutting edges defined by the blades mounted in the razor cartridge, a spring or other resilient member is employed to urge the cutting edges toward a hirsute surface. A problem sometimes encountered is that the force that urges the razor cartridge against a surface being shaved must also be overcome when changes in surface contour are encountered. This requires additional force to be exerted against the surface being shaved resulting in a heightened potential for irritation and injury.

Based on the forgoing, it is the general object of the present invention to improve upon or overcome the problems and drawbacks associated with known prior art shaving implements.

### SUMMARY OF THE INVENTION

The present invention resides in one aspect in a shaving implement having a handle and a razor cartridge pivotally coupled thereto for movement about a pivot axis. The razor cartridge includes a leading surface and a trailing surface with at least one blade positioned therebetween and defining an, at least partially, exposed cutting edge. The pivot axis is located adjacent to the leading surface so that during a shaving operation, externally applied forces generated by drawing the razor cartridge and thereby the exposed portion of the cutting edge over a hirsute surface, causes the razor cartridge and the cutting edge to rotate into the hirsute surface.

A shave plane extends between the leading surface and the trailing surface and is generally defined as the plane of contact with the skin being shaved. The pivot axis while being adjacent the leading surface can be located in a zone or number of different positions. For example, the pivot axis can lie on the shave plane. Alternatively, the pivot axis can lie below the shave plane or be positioned such that it would extend within a user's skin during a shaving operation. Accordingly, the pivot axis can reside within a zone extending above and below the shave plane in the vicinity of the leading surface.

The present invention also resides in a shaving implement that includes a shaving head coupled to a handle, the shaving head defining an interior area. At least one cartridge retainer is coupled to the shaving head with a portion of the cartridge retainer being located within the interior area and another portion projecting outwardly from the shaving head. A razor cartridge adapted to be mounted either permanently or releasably to the cartridge retainer is also provided and includes a pair of generally opposed mounting members. Each mounting member defines a retainer surface that is slidably engageable with at least a portion of one of a pair of generally opposed ends defined by the cartridge retainer.

In the preferred embodiment of the present invention, the retaining surfaces are arcuate and extend towards one another. The ends defined by the cartridge retainer are each complimentarily shaped to slidably engage one of the retaining surfaces of the razor cartridge. Preferably, the mounting members each include a slot defined in part by one of the arcuate retaining surfaces. Each of the ends defined by the cartridge retainer at least partially and slidably engage one of the slots when the razor cartridge is coupled to the cartridge retainer. The razor cartridge can also include a pair of guide surfaces, each located adjacent one of the mounting members. A portion of each of the ends defined by the cartridge retainers slidably engages one of the guide surfaces when the razor cartridge is coupled to the cartridge retainer.

An advantage of the present invention is that during a shaving operation, the location of the pivot axis will cause the razor cartridge to rotate into the hirsute surface without the need for any additional biasing force thereby providing a closer, more comfortable shave than has historically been possible with known prior art razors.

### BRIEF DESCRIPTION OF THE DRAWINGS

FIG. 1 is a perspective view of a shaving head that embodies the present invention.

FIG.2 is a side elevational view of the shaving head of FIG. 1.

FIG. 3 is a partial perspective exploded view of the shaving head of FIG. 1.

FIG. 4 is a partial perspective view of the shaving head of FIG. 1.

FIG. 5 is a partial, cross-sectional view of the shaving head of FIG. 1.

FIG. 6 schematically illustrates a pivot axis located on the shave plane of a shaving implement embodying the present invention.

FIG. 7 schematically illustrates a pivot axis zone of a shaving implement embodying the present invention.

### DETAILED DESCRIPTION OF THE PREFERRED EMBODIMENTS

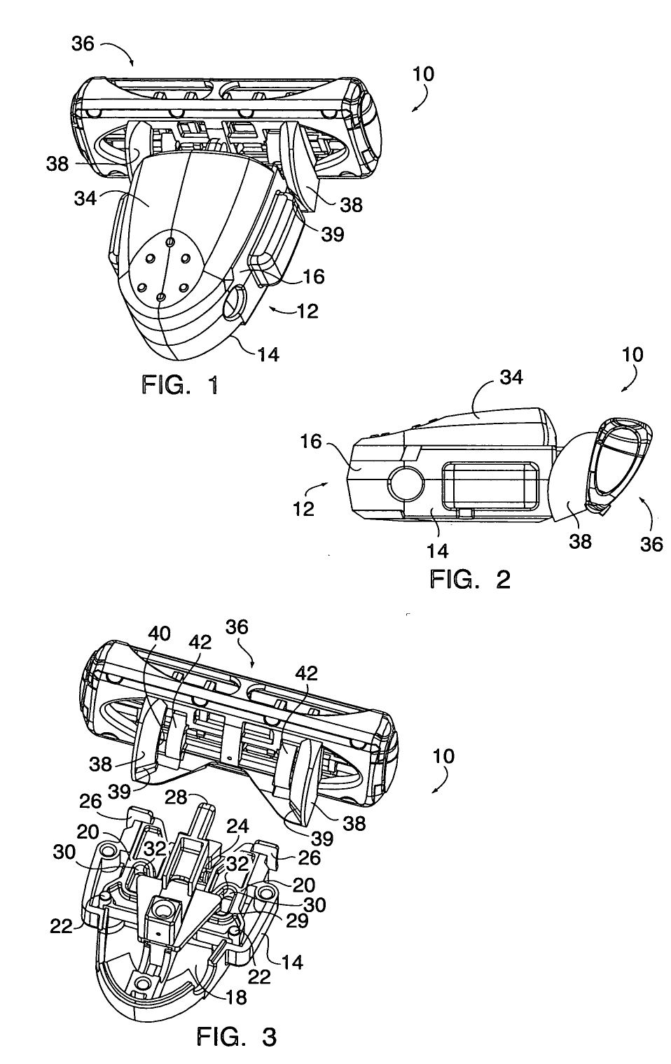

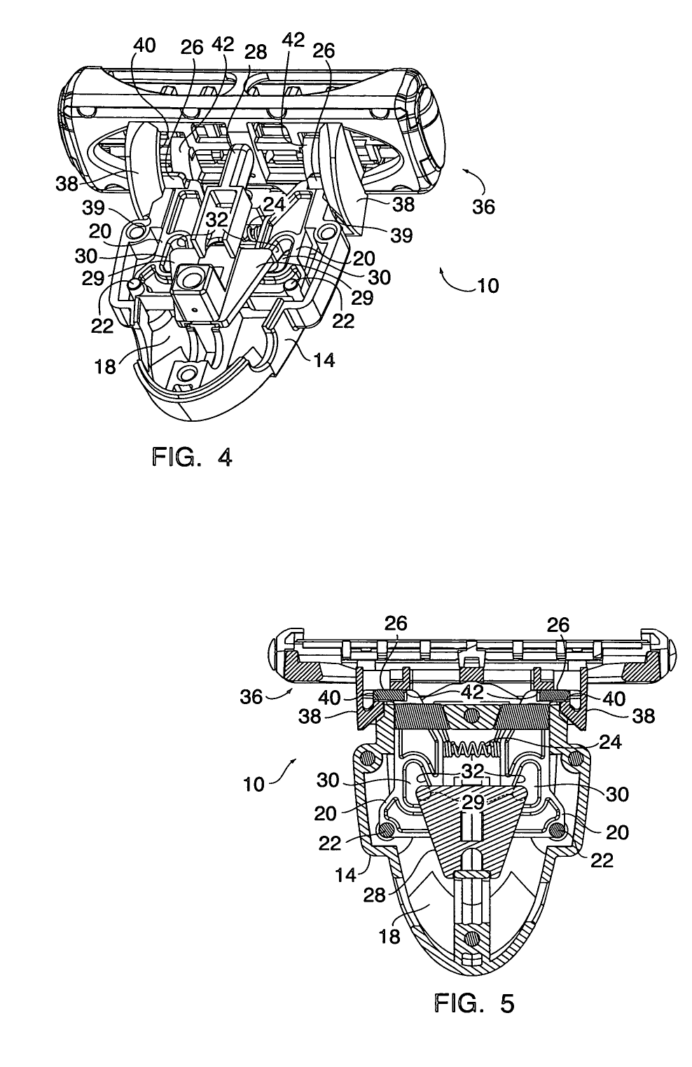

As shown in FIGS. 1 and 2, a shaving head, shown in the illustrated embodiment without a handle attached thereto, is generally designated by the reference number 10. The shaving head 10 includes a housing 12 comprising first and second housing sections, 14 and 16 respectively, attached to one another. The first and second housing sections, 14 and 16 respectively, cooperate to define an interior area, best seen in FIGS. 3 and 4.

As shown in FIGS. 3 and 4, a pair of cartridge retainers 20 are partially positioned in the interior area 18. Each cartridge retainer 20 is pivotally and snappingly mounted to a post 22 projecting from the first housing section 14 for movement between a cartridge retaining position and a cartridge releasing position. A spring 24 is interposed between and engages each of the cartridge retainers 20 to normally urge the cartridge retainers toward the cartridge retaining position. Each of the cartridge retainers 20 has an end 26 included on a portion of the cartridge retainer that projects outwardly from the housing 12. The ends 26 are generally opposed to one another, arcuate in shape, and, as will be explained in detail below, are adapted to slidably engage mounting members defined by a razor cartridge.

Referring to FIG. 3, a plunger 28 is slidably mounted to the first housing section 14 for movement between an extended and a retracted position. The plunger 28 includes a pair of generally opposed projections 29 extending therefrom, each engaging a slot 30 defined by one of the cartridge retainers 20. Each of the slots 30 are defined in part by an inclined peripheral surface 32. As the plunger 28 moves from the retracted to the extended position, the projections 29 progressively engage the slots 30, thereby causing the cartridge retainers 20 to move from the cartridge retaining position toward the cartridge releasing position. The spring 24 normally biases the cartridge retainers 20 toward the cartridge retaining position, and thereby, due to the interaction between the projections 29 and the inclined surfaces 32, the plunger toward the retracted position.

Referring back to FIG. 1, the shaving head 10 includes an actuator 34 a portion of which extends through the second housing section 16 and engages the plunger 28. The actuator 34 is manually manipulable between a neutral position wherein the plunger 28 is in the retracted position, and the cartridge retainers 20 are in the cartridge retaining position; and a forward position wherein the plunger 28 is in the extended position, and the cartridge retainers 20 are in the cartridge releasing position.

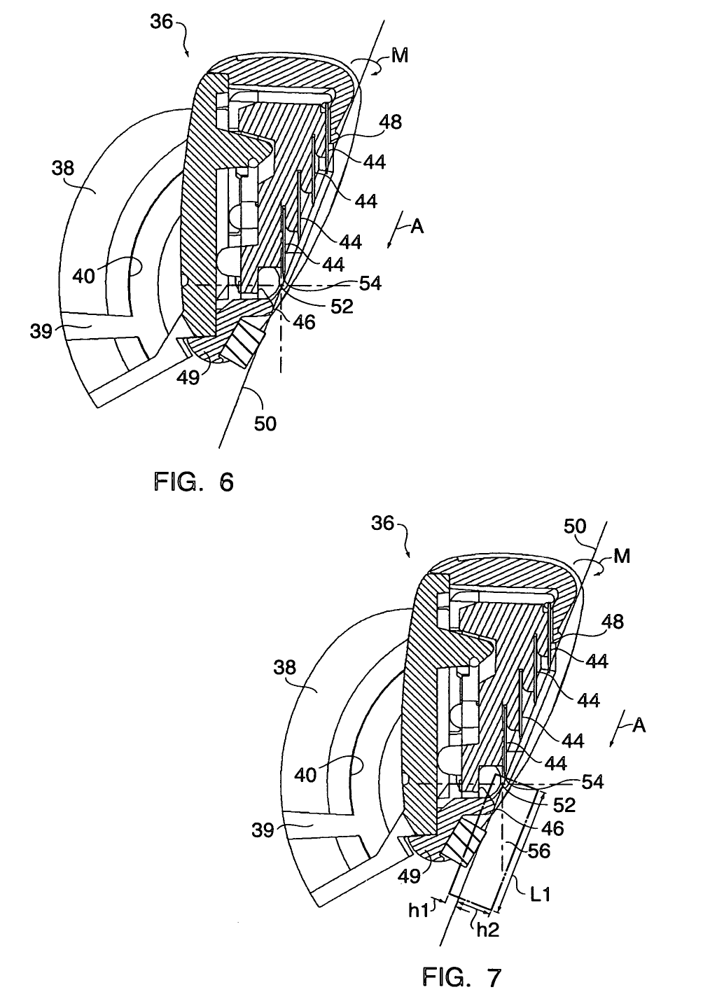

Referring now to FIGS. 1-4, the shaving head 10 further includes a razor cartridge generally designated by the reference number 36 that includes a pair of generally opposed mounting members 38 projecting therefrom. Each mounting member 38 defines a slot 39 defined in part by an arcuate retaining surface 40, FIG. 6, that is slidably engageable with at least a portion of one of the ends 26 defined by each cartridge retainer 20. In the illustrated embodiment, the arcuate retaining surfaces 40 are shown as each extending, one toward the other, however, the present invention is not limited in this regard. The razor cartridge 36 also includes a pair of arcuate guides 42, one adjacent to each of the retaining surfaces 40. When the razor cartridge is mounted to the cartridge retainers 20, a portion of the ends 26 defined by the cartridge retainers resides in the slots 39 and another portion of the ends slidably engages the guides 42.

Referring to FIG. 6, the razor cartridge 36 shown schematically therein includes four razor blades 44. The razor cartridge 36 also includes a leading surface 46 and a trailing surface 48. As used herein the terms leading and trailing denote the surface that one or more hairs protruding from a user's skin will encounter first and last respectively when the razor cartridge 36 is drawn over a hirsute surface in a shaving direction as indicated by the arrow labeled “A”. The leading surface 46 is part of a guard bar 49 for stretching a users skin prior to encountering a razor blade. The guard bar 49 can be a separate component as is illustrated, or it can be integral with the razor cartridge 36. A contact or shave plane is defined in part by the line labeled 50. The shave plane 50 extends between the leading and trailing surfaces, 46 and 48 respectively, approximately tangent thereto and is generally defined as the plane of contact with a surface being shaved. With the shaving head 10 configured as described above, both the mounting members 38 and the ends 26 of the cartridge retainers 20, are positioned so that a pivot axis 52, FIG. 6 is located adjacent the leading surface 46 and a cutting edge 54 defined by the razor blade 44 closest to the leading surface.

With the pivot axis 52 located as described above, an overturn moment “M” will be generated when the shaving head 10 is drawn in the shaving direction “A”, over a hirsute surface. The overturn moment “M” causes the razor cartridge to rotate into the hirsute surface thereby allowing the blades 44 to cut hair more efficiently. While the pivot axis 52 has been shown and described as being on the shave plane 50, the present invention is not limited in this regard as the pivot axis can be located any where within a pivot axis zone 56 as is shown in FIG. 7. The pivot axis zone 56 extends from the cutting edge 54 closest to the leading surface 46 a first distance “h1” extending above the shaving plane 50 approximately perpendicular thereto, and a second distance “h2” extending away from and approximately perpendicular to the shaving plane. The pivot axis zone 56 further extends from the cutting edge 54 toward and past the leading surface 46 approximately parallel to the shave plane 50 for a distance “L1”. The size of the pivot axis zone 56 is such that if the pivot axis 52 is located anywhere within the zone, a sufficient overturn moment “M” will still be generated during a shaving operation.

As will be recognized by those skilled in the pertinent art to which the invention pertains, numerous changes and modifications may be made to the above described and other embodiments of the present invention without departing from the broader aspects of the present invention.

What is claimed is:

1. A shaving implement comprising:
a shaving head;
a razor cartridge including a leading surface and a trailing surface and at least one blade positioned between said leading and trailing surfaces, said blade defining a cutting edge that is at least partially exposed;
said razor cartridge being pivotally couplable to said shaving head for rotational movement about a pivot axis; and wherein
said pivot axis is located adjacent to said leading surface so that during a shaving operation, externally applied forces generated by drawing said razor cartridge and thereby said exposed portion of said cutting edge over a hirsute surface, causes said razor cartridge and said cutting edge to rotate into said hirsute surface.

2. A shaving implement as defined by claim 1 wherein said leading surface is defined by a guard bar coupled to said razor cartridge.

3. A shaving implement as defined by claim 1 wherein a shave plane extends between said leading surface and said trailing surface, said shave plane being generally defined as a plane of contact between said shaving implement and said hirsute surface.

4. A shaving implement as defined by claim 3 wherein said pivot axis is coincident with said shave plane.

5. A shaving implement as defined by claim 3 wherein said pivot axis is located away from said shaving plane and wherein, during a shaving operation, said pivot axis is located within said hirsute surface.

6. A shaving implement as defined by claim 3 wherein said pivot axis is positioned within a pivot axis zone extending from a cutting edge defined by a razor blade adjacent said leading surface, a first distance above said shaving plane approximately perpendicular thereto and a second distance below said shaving plane and approximately perpendicular thereto, said pivot axis zone further extending approximately parallel to said shaving plane.

7. A shaving implement as defined by claim 1 further comprising:
a shaving head including at least one cartridge retainer coupled thereto, a portion of which projects outwardly from said shaving head;
said at least one cartridge retainer including a pair of generally opposed ends; and
said razor cartridge defining a pair of generally opposed mounting members each defining a retaining surface slidably engageable with at least a portion of one of said ends defined by said cartridge retainer.

8. A shaving implement as defined by claim 7 wherein:
said mounting members each define an arcuate retaining surface; and
said ends defined by said cartridge retainer are each complimentarily shaped to slidably engage said arcuate retaining surfaces.

9. A shaving implement as defined by claim 8 wherein:
said mounting members each include a slot defined in-part by said retaining surface; and
each of said ends at least partially engages one of said slots when said razor cartridge is coupled to said cartridge retainer.

10. A shaving implement as defined by claim 9 wherein:
said razor cartridge further comprises a pair of guide surfaces, each located adjacent one of said mounting members; and wherein
a portion of each of said ends slidably engages one of said guide surfaces when said razor cartridge is coupled to said cartridge retainer.

11. A shaving implement as defined by claim 10 wherein each of said guide surface is arcuate.

12. A shaving implement as defined by claim 7 wherein said ends of said cartridge retainer are movable between a cartridge retaining and a cartridge ejecting position, said ends being normally biased toward said cartridge retaining position.

13. A shaving implement as defined by claim 12 wherein:
said housing defines an interior area;
said at least one cartridge retainer includes a pair of cartridge retainers each defining one of said ends; and
each cartridge retainer is at least partially positioned in said interior area and is pivotally coupled to said housing for movement between said cartridge retaining position and said cartridge releasing position.

14. A shaving implement as defined by claim 13 further comprising:
a plunger, a portion of which is disposed within said interior area and a portion extending outwardly from said interior area;
said plunger being movable between an extended and a retracted position and including a pair of generally opposed projections each slidably engageable with a slot defined by one of said cartridge retainers; and
said slot being defined in part by an inclined peripheral surface so that when said plunger moves from said retracted to said extended position each of said projections progressively engages one of said inclined peripheral surfaces thereby moving said cartridge retainers from said cartridge retaining position to said cartridge ejecting position.

15. A shaving implement as defined by claim 14 further comprising:
an actuator coupled to said housing and said plunger; and wherein
said actuator is manually manipulable between a neutral position wherein said plunger is in said retracted position and said cartridge retainers are each in said cartridge retaining position, and a forward position wherein said plunger is in said extended position and said cartridge retainers are each in said cartridge releasing position.

16. A shaving implement comprising:
a shaving head including a housing having an interior area;
a pair of cartridge retainers, each having a portion positioned in said interior area and pivotally coupled to said housing, a portion of each cartridge retainer extending outwardly from said housing;
a razor cartridge defining a pair of generally opposed mounting members each defining an arcuate retaining surface slidably engageable with at least a portion of a mating arcuate end defined by each said cartridge retainers thereby allowing said razor cartridge to rotate about a pivot axis;
said razor cartridge including a leading surface and a trailing surface and at least one blade positioned between said leading and trailing surfaces, said blade defining a cutting edge that is at least partially exposed; and wherein
said pivot axis is located adjacent to said leading surface so that during a shaving operation, externally applied forces generated by drawing said razor cartridge and thereby said exposed portion of said cutting edge over a hirsute surface, causes said razor cartridge and said cutting edge to rotate into said hirsute surface.

17. A shaving implement as defined by claim 16 wherein:
said razor cartridge includes a guard bar; and
said guard bar defines said leading surface.

18. A shaving implement as defined by claim 16 wherein a shave plane extends between said leading surface and said trailing surface, said shave plane being generally defined as a plane of contact with said hirsute surface.

19. A shaving implement as defined by claim 18 wherein said pivot axis is on said shave plane.

20. A shaving implement as defined by claim 18 wherein said pivot axis is located away from said shaving plane and wherein, during a shaving operation, said pivot axis is located within said hirsute surface.

21. A shaving implement as defined by claim 18 wherein said pivot axis is positioned within a pivot axis zone extending from a cutting edge defined by a razor blade adjacent said leading surface, a first distance extending above said shaving plane approximately perpendicular thereto and a second distance below and approximately perpendicular to said shaving plane, said pivot axis zone further extending parallel to said shaving plane.
